(19) United States
(12) Patent Application Publication
(10) Pub. No.: US 2013/0052443 A1
(43) Pub. Date: Feb. 28, 2013

(54) INTERIOR SUBSTRATE MATERIAL AND METHOD OF MANUFACTURING THE SAME

(71) Applicant: Noriaki Nakagawa, Inuyama-shi (JP)

(72) Inventor: Noriaki Nakagawa, Inuyama-shi (JP)

(73) Assignee: NAKAGAWA SANGYO CO., LTD., Inuyama-shi (JP)

(21) Appl. No.: 13/569,873

(22) Filed: Aug. 8, 2012

(30) Foreign Application Priority Data
Aug. 24, 2011 (JP) 2011-182851

(51) Int. Cl. B32B 27/04; B32B 17/02; B29C 70/08

(52) U.S. Cl. 428/220; 264/257; 264/258; 442/335; 442/374

(57) ABSTRACT

A method of manufacturing an interior substrate material, e.g., for an automobile includes impregnating a sheet-shaped, nonwoven mat material, which consists of glass fibers, with a urethane-yielding liquid, and heating the mat material impregnated with the urethane-yielding liquid to foam and heat cure the urethane-yielding liquid in the mat material, thereby producing the interior substrate material.

### CROSS-REFERENCE

This application claims priority to Japanese patent application no. 2011-182851 filed on Aug. 24, 2011, the contents of which are incorporated by reference as if fully set forth herein.

### BACKGROUND OF THE INVENTION

1. Field of the Invention

The present invention relates to a method of manufacturing an interior substrate material, e.g., for an automobile. In certain embodiments, the present teachings provide relatively lightweight interior substrate materials having satisfactory stiffness at a lower manufacturing cost.

2. Description of the Related Art

Interior substrate materials for an automobile, especially an interior substrate material used for an automobile ceiling, must have a light weight and a high stiffness (rigidity). A known example of an interior substrate material for an automobile has the structure shown in FIG. 6, in which two fiberglass chopped strand mats (CSM) 92 are respectively bonded by means of an isocyanate adhesive 93 to the upper and lower surfaces of a plate-shaped hard urethane foam 91.

The above-described known interior substrate material is manufactured in the following manner. A urethane foam block body 94 is produced by impingement mixing of an isocyanate with a polyol (polyalcohol) and curing (FIG. 7(A)). The resulting block body 94 is then sliced into a specific size (width) to form the plate-shaped hard urethane foam 91 (FIG. 7(B)). Then, two chopped strand mats 92, to which the adhesive 93 has been applied, are respectively bonded to the upper and lower surfaces of the urethane foam 91 (FIG. 7(C)). A further structural material, such as a skin, is superimposed or overlapped on top of and underneath the thus-formed interior substrate material, and hot pressed to form an interior material such as a ceiling material RF (FIG. 7(D)).

Japanese Patent Laid-Open No. 2005-226178 discloses an interior substrate material for an automobile, which has a construction in which thermoplastic resin sheet layers are respectively bonded to the upper and lower surfaces of a fiber layer via respective bonding layers.

However, the known interior substrate materials for automobiles manufactured according to the known manufacturing methods are disadvantageous, because they require the above-described slicing process, bonding process, etc., which are labor-intensive and thus costly.

### SUMMARY OF THE INVENTION

It is an object of the present teachings to provide a lower-cost method for manufacturing a relatively lightweight interior substrate material, e.g., for an automobile, having a sufficient or satisfactory stiffness (rigidity), as well as an interior substrate material produced thereby.

In one aspect of the present teachings, a method of manufacturing an interior substrate material, e.g., for an automobile includes impregnating a sheet-shaped mat material consisting of a glass fiber nonwoven fabric with a urethane yielding liquid, and then heating the mat material impregnated with the urethane yielding liquid to bring about urethane foaming in the mat material and heat curing.

The manufacturing method of the first aspect eliminates the need for a slicing process and a bonding process, thereby reducing manufacturing costs as compared to the known art, while still providing a lightweight interior substrate material having sufficient stiffness.

In another aspect of the present teachings, a method of manufacturing an interior substrate material for an automobile includes impregnating a sheet-shaped mat material consisting of a glass fiber nonwoven fabric with a urethane yielding liquid, superimposing or overlapping at least one additional structural material onto at least one surface of the mat material impregnated with the urethane yielding liquid and heating the entire unit or composite to bring about urethane foaming in the mat material and heat curing.

In such a manufacturing method, the interior substrate material is simultaneously integrated with at least one other structural material, such as a skin covering at least one surface of the interior substrate material, thereby reducing manufacturing costs.

In another aspect of the present teachings, an interior substrate material, e.g., for an automobile, contains a urethane foam integrally produced in a sheet-shaped mat material consisting of a glass fiber nonwoven fabric.

The glass fibers preferably an (average) outer diameter in the range of 3 μm to 17 μm, more preferably between 7-11 μm, even more preferably about 9 μm. The thickness of the mat material will be changed depending upon its application; however, if the mat material is used for an automobile ceiling, the thickness thereof is preferably 3 to 10 mm.

The urethane yielding liquid comprises, for example, a mixed liquid obtained by impingement mixing of an isocyanate with a polyol.

If the above-described interior material is used as a ceiling material for an automobile, the at least one other structural material may be, e.g., one or more of a skin material, an impermeable film material, a scrim material, etc.

Further objects, embodiments, designs and advantages of the present invention will become apparent upon reading the following detailed description and claims in view of the appended drawings.

### BRIEF DESCRIPTION OF THE DRAWINGS

FIG. 1 is a schematic view showing a configuration of an apparatus used for manufacturing an interior substrate material according to the present teachings.

FIG. 2 is a perspective view showing a step of the manufacturing process according to the present teachings.

FIG. 3 is a perspective view showing another step of the manufacturing process according to the present teachings.

FIG. 4 is a sectional view showing another step of the manufacturing process according to the present teachings.

FIG. 5 is a perspective view of a representative ceiling material produced according to the present teachings.

FIG. 6 is a cross-sectional view showing an example of a known interior substrate material for an automobile.

FIGS. 7(A)-7(D) show perspective views of steps of a known process for manufacturing the interior substrate material of FIG. 6.

### DETAILED DESCRIPTION OF THE PREFERRED EMBODIMENT

The embodiment described below is only one exemplary embodiment of the present teachings, and various design modifications and/or improvements made by a person skilled in the art without departing from the spirit of the present invention are embraced in the scope of the present invention.

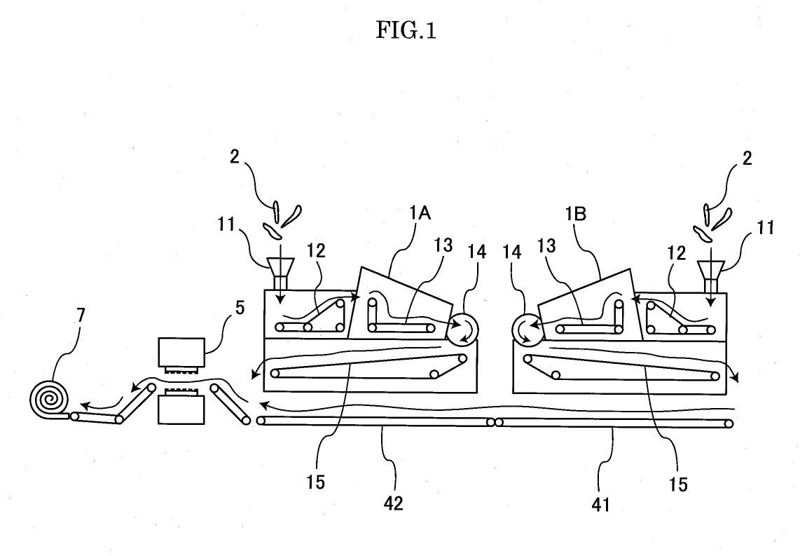

In order to manufacture an interior substrate material, e.g., for an automobile according to the present teachings, a nonwoven mat material is first produced. A representative manufacturing machine and process therefor are shown in FIGS. 1-4.

Referring to FIG. 1, two airlay-type forming machines 1A and 1B are provided, and glass fibers 2 are charged into the respective forming machines 1A and 1B. E-glass fibers (i.e. fibers formed from alumino-borosilicate glass having less than 1% w/w alkali oxides) are preferably used as the glass fibers. More specifically, the glass fibers 2 are charged through respective chutes 11, then conveyed by respective first conveyors 12 into each of the forming machines 1A and 1B (hereinafter, the direction of movement is shown by arrows in FIG. 1), and are thereafter moved to respective main cylinders 14 by respective second conveyors 13 at the next stage. At this time, the glass fibers are in a state of being uniformly aligned in the width direction.

After the glass fibers are fibrillated (defibrated) and blown off the respective main cylinders 14, the glass fibers are conveyed by respective third conveyors 15 while being formed into a sheet shape on the third conveyor 15. Thereafter, the glass fiber sheets are discharged from the respective forming machines 1A and 1B. More specifically, the glass fiber sheet discharged from the forming machine 1A is superimposed (e.g., stacked or placed in an overlapping manner) on top of the glass fiber sheet discharged from the forming machine 1B via conveyors 41 and 42 and the stacked glass fiber sheets are then transferred as a whole to a needle punch 5 at the next stage. It is preferable to form the two stacked glass fiber sheets, i.e. in a double layer, to reduce local variations in area density or surface density (i.e. mass per unit area).

The double layer of glass fiber sheets is then formed into a nonwoven sheet material by entangling the fibers with each other using a needle punch 5. The nonwoven sheet material is then wound into a roll 6 as a mat material 7.

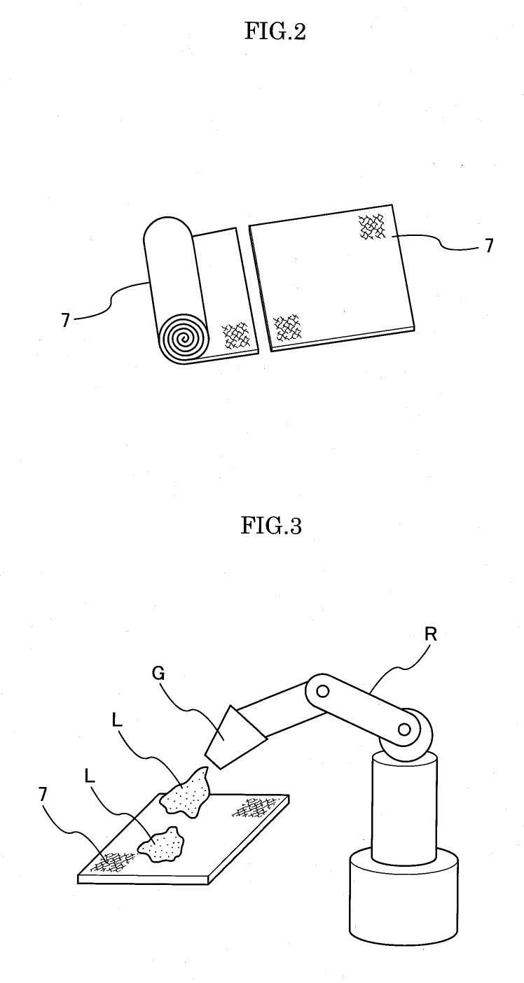

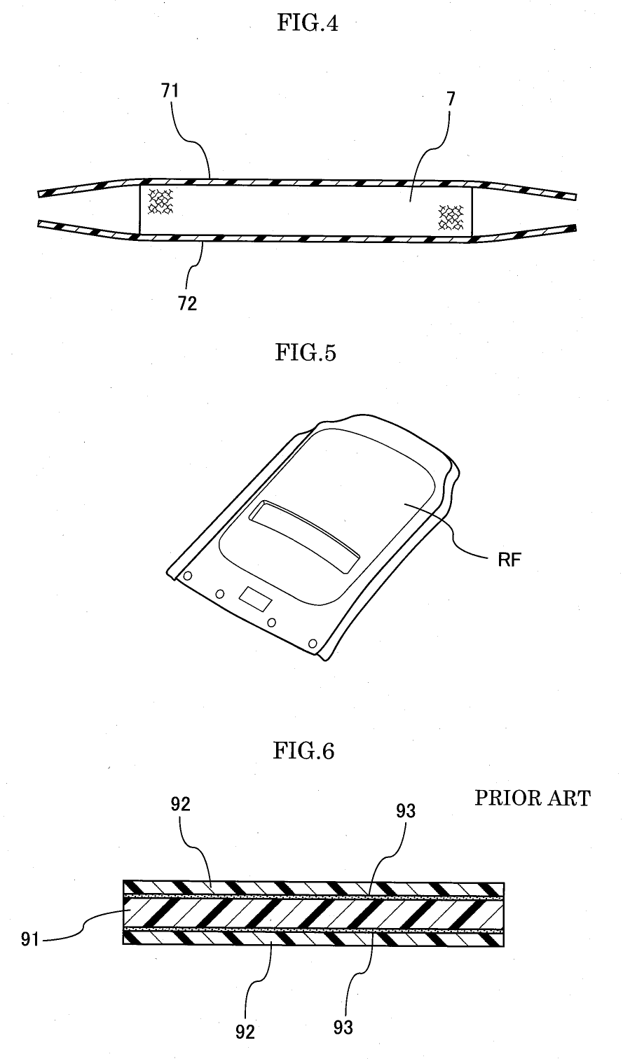

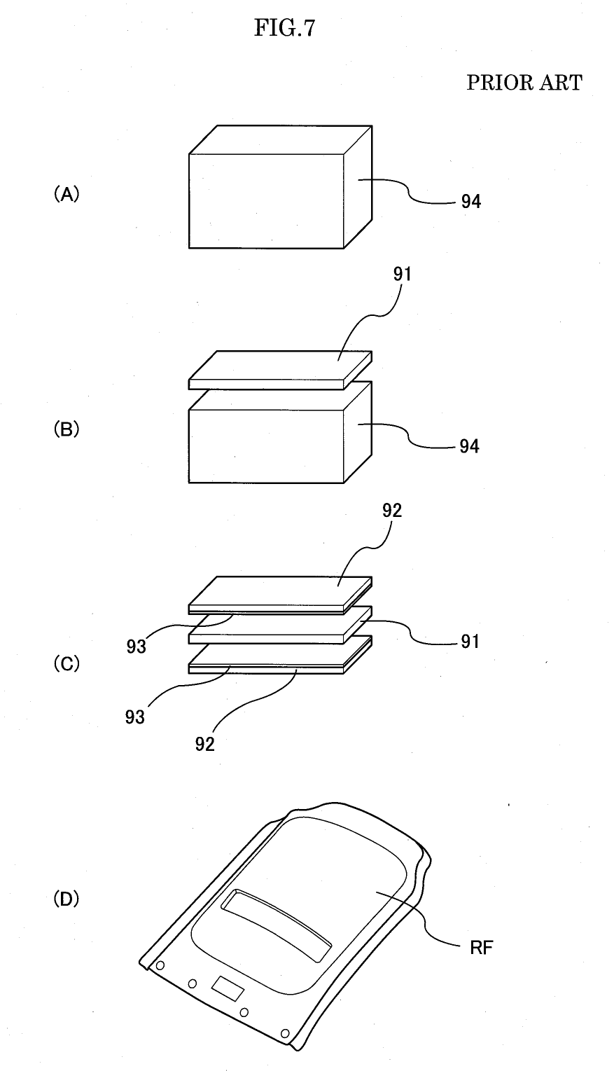

As shown in FIG. 2, the mat material 7 is unrolled and cut into a specific size. Then, as shown in FIG. 3, a mixed liquid L, which is a urethane yielding liquid obtained by impingement mixing an isocyanate with a polyol, is sprayed from a spray gun G mounted on an industrial robot R so that the mat material 7 becomes impregnated with the mixed liquid L. Then, as shown in FIG. 4, one or more additional structural materials, such as a skin material 71 and an impermeable film material 72, are placed in an overlapping manner (superimposed) on the upper and lower surfaces of the mat material 7 impregnated with the mixed liquid L.

The entire assembly is then hot pressed at a temperature of 110 to 150° C., whereby an interior substrate material is formed after urethane foaming is effected within the mat material 7. The entire laminate is heat cured while simultaneously causing the respective materials to adhere to each other in order to form, e.g., a ceiling material RF, as shown in FIG. 5, which is a representative, non-limiting embodiment of an interior substrate material according to the present teachings.

The thus-manufactured ceiling material RF has a weight per unit area (area density or surface density) of about 400 g/m², which is lighter than the weight per unit area of the ceiling material manufactured according the above-described known method, which has an area density of about 500 g/m². Moreover, the thus-manufactured ceiling material also has a stiffness (rigidity) of 30-40 N/cm, which is similar to the stiffness of the above-described known ceiling material.

This stiffness was measured as follows. A test specimen measuring 150 mm long and 50 mm wide was cut out of the ceiling material RF, and the cut-out test specimen was supported by a pair of supports spaced at a distance of 100 mm with the test specimen being set at a position symmetrical in the right-and-left direction. A pressing element having a radius of 5 mm was lowered at a rate of 50 mm/min to press down (deflect) the central portion of the test specimen. The force necessary to bend (curvedly displace or deflect) the central portion downward by 1 cm was measured to determine the stiffness.

In this embodiment, the interior substrate material and the interior material are formed at the same time by overlapping or superimposing any other required construction (structural) material(s) on the mat material. However, only the interior substrate material may be formed without superimposing any other construction (structural) materials.

While the present teachings have described with respect to an interior substrate material for automobiles, it should be understood that the present teachings are not limited to automobiles and can be advantageously utilized in a variety of fields, including but not limited to trucks, boats, planes, or any other field in which a lightweight, stiff material is desirable.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved interior substrate materials and methods for manufacturing and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

1. A method of manufacturing an interior substrate material, comprising:
impregnating a sheet-shaped, nonwoven mat material, which consists of glass fibers, with a urethane-yielding liquid, and
heating the mat material impregnated with the urethane-yielding liquid to foam and heat cure the urethane-yielding liquid in the mat material.

2. The method of claim 1, further comprising:
superimposing at least one other structural material on at least one surface of the mat material impregnated with the urethane-yielding liquid prior to the heating step.

3. The method according to claim 2, wherein the at least one structural component is a skin material, an impermeable film material and/or a scrim material.

4. The method according to claim 3, wherein the urethane-yielding liquid comprises a mixture of isocyanate and polyol.

5. The method according to claim 4, wherein the glass fibers have an average outer diameter of 3 μm to 17 μm.

6. The method according to claim 5, wherein the glass fibers are E-glass fibers.

7. The method according to claim 6, wherein the mat material has a thickness of 3 to 10 mm.

8. The method according to claim 7, wherein the heating step comprises hot pressing at a temperature of 110 to 150° C.

9. The method according to claim 1, wherein the at least one structural component is a skin material, an impermeable film material and/or a scrim material.

10. The method according to claim 1, wherein the urethane-yielding liquid comprises a mixture of isocyanate and polyol.

11. The method according to claim 1, wherein the glass fibers have an average outer diameter of 3 μm to 17 μm.

12. The method according to claim 1, wherein the glass fibers are E-glass fibers.

13. The method according to claim 1, wherein the mat material has a thickness of 3 to 10 mm.

14. The method according to claim 1, wherein the heating step comprises hot pressing at a temperature of 110 to 150° C.

15. An interior substrate material produced according to the method of claim 8.

16. The interior substrate material according to claim 15, wherein the interior substrate material has a stiffness of 30-40 N/50 mm.

17. The interior substrate material according to claim 15, wherein the interior substrate material has a thickness of 3-10 mm.

18. An interior substrate material produced according to the method of claim 1.

19. The interior substrate material according to claim 18, wherein the interior substrate material has a stiffness of 30-40 N/50 mm.

20. The interior substrate material according to claim 19, wherein the interior substrate material has a thickness of 3-10 mm.
